(19) United States
(12) Patent Application Publication
(10) Pub. No.: US 2006/0288017 A1
(43) Pub. Date: Dec. 21, 2006

(54) User-specific product documentation

(76) Inventor: Oliver C. Goetz, Altrip (DE)

Correspondence Address: FISH & RICHARDSON, P.C., PO BOX 1022, MINNEAPOLIS, MN, 55440-1022, US

(21) Appl. No.: 11/155,820

(22) Filed: Jun. 17, 2005

(51) Int. Cl. G06F 7/00

(52) U.S. Cl. 707/100

(57) ABSTRACT

Methods and systems, including computer program products, implementing techniques for generating documentation for a product. The techniques include receiving a set of feature descriptions for a product, receiving a document template, receiving user data about a first user and different user data about a second user, and receiving mapping information that maps user data values to product features; then, for each user, using the mapping information and the respective user data to identify product features that are of interest to the user, and generating documentation for the product specific to the user, including reading the document template, and for each feature description referred to in the document template, adding the feature description to the documentation if the feature description describes one of the product features identified as being of interest to the user, otherwise, not adding the feature description to the documentation.

### BACKGROUND

The present invention relates to data processing by digital computer, and more particularly to generating documentation for a product.

Products are commonly developed by a team of designers or engineers where each engineer is tasked with developing a particular portion of the product. Often, however, the entire engineering team is given a single specification of the product, and it is up to each engineer to identify the portions of the specification that are relevant to his task.

Some products are available for purchase in multiple different configurations. Examples of such products are cars, houses, software programs, hardware devices, and educational products. For example, cars are available in a standard or base model and also in one or more higher-end models that include additional features not included in the base model.

Typically, when an end user purchases a particular configuration of a product, the end user receives documentation (e.g., a user's manual) that describes every possible configuration of the product. The burden is on the end user to filter out the irrelevant portions of the documentation.

### SUMMARY OF THE INVENTION

The present invention provides methods and systems, including computer program products, that implement techniques for generating documentation for a product. In one general aspect, the techniques include receiving a set of feature descriptions for a product, receiving a document template, receiving user data about a first user and different user data about a second user, and receiving mapping information that maps user data values to product features; then, for each user, using the mapping information and the respective user data to identify product features that are of interest to the user, and generating documentation for the product specific to the user, including reading the document template, and for each feature description referred to in the document template, adding the feature description to the documentation if the feature description describes one of the product features identified as being of interest to the user, otherwise, not adding the feature description to the documentation.

Implementations of the invention can include one or more of the following features. The respective user data identifies a user role performed by the respective user and the mapping information maps user roles to product features. The respective user data identifies sales items in a purchase order placed by the respective user and the mapping information map sales items to product features. The documentation generated for the first user can include a different subset of the feature descriptions than the documentation generated for the second user.

The set of feature descriptions for the product can include at least one feature description that includes graphics. The document template can further include references to general content. Generating documentation for the product can further include adding the general content to the documentation. The product can be an automobile. The product can be a software program.

The invention can be implemented to realize one or more of the following advantages. The documentation is user-specific. Users only receive documentation that is relevant to them. The size of the documentation is reduced. This reduces the time required by the user to learn the product. With printed documentation, this also saves paper. The user-specific documentation can be generated automatically. One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1 illustrates a system in accordance with one implementation of the invention.

FIG. 2 illustrates a method for designing documentation in accordance with one implementation of the invention.

FIGS. 3 and 4 illustrate a method for assembling documentation in accordance with one implementation of the invention.

FIGS. 5A and 5B illustrate product features and feature descriptions.

FIG. 6 illustrates mapping information.

FIG. 7 illustrates a document template.

FIGS. 8A and 8B illustrate user data values and features identified based on user data values.

FIGS. 9A and 9B illustrate product documentation generated for a first and second user.

Like reference numbers and designations in the various drawings indicate like elements.

### DETAILED DESCRIPTION

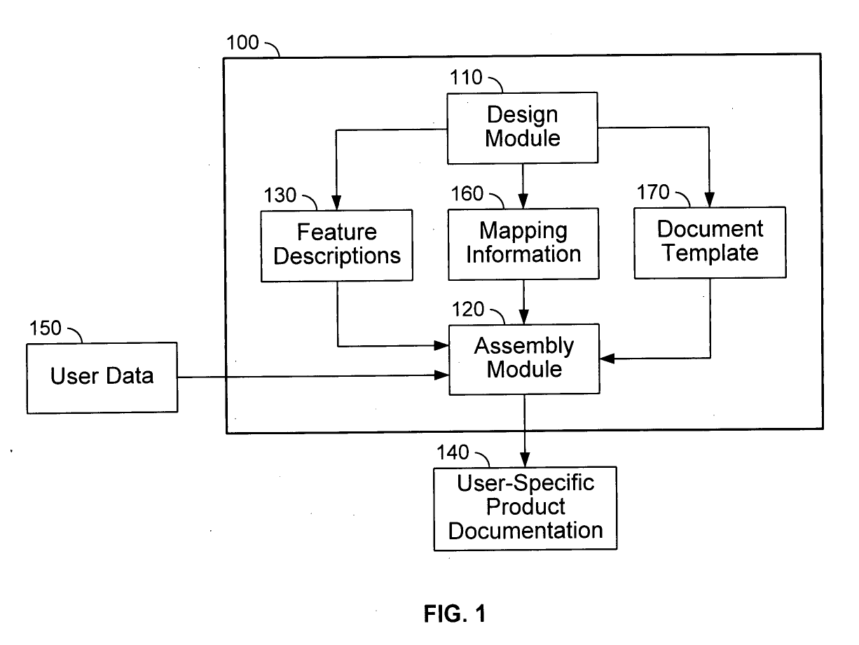

As shown in FIG. 1, a system 100 for generating documentation for a product in accordance with one implementation of the invention includes a design module 110 and an assembly module 120.

A documentation designer interacts with the design module 110 to define a set of feature descriptions 130, mapping information 160, and a document template 170. The document template refers to one or more of the feature descriptions and defines a layout for arranging the feature descriptions as a single document. Each feature description describes a feature of the product. If there are multiple versions of a single feature, each version can be described separately. The feature descriptions can include a variety of different types of information including, but not limited to, text, graphics, and audio or video data. In the implementation described here, the feature descriptions are optional descriptions, that is, descriptions that are not necessarily included in the documentation for the product.

The mapping information maps user data values to product features. The mapping information can be part of the document template or separate from the document template. The mapping information will be described in more detail below.

The assembly module 120 uses the feature descriptions, mapping information, and document template defined by the design module 110 to generate documentation 140 for the product. The documentation 140 can be a printed document, for example, a user's manual, or the documentation 140 can be an electronic document, for example, a help file. The documentation 140 can be documentation for an end user, for example, a customer that has purchased or licensed the product, or for an internal user, for example, a product developer or manager.

The documentation 140 is user-specific in that only the product features that are determined to be of interest to the user are described in the documentation 140. For example, if the user has purchased a particular model of the product, then the documentation describes only the features that are included in the particular model purchased by the user. Features included in other models of the product, but not in the particular model purchased by the user, would not be described in the documentation 140. In the case of an internal user, if the user's role or position within the company only relates to particular features of the product, then the documentation describes only the particular product features that are relevant to the user's role.

The product features of interest to the user are determined by obtaining user data 150 about the user and comparing the obtained user data to the mapping information 160. The mapping information maps user data values to product features. The mapping information is not specific to a particular user. The same mapping information can be used with different users.

Where the intended user is an end user, the user data can identify sales items in a purchase order placed by the user, in a license for the product granted to the user, or in a manufacturing order for a product being built for the user. Where the intended user is an internal user, the user data can identify the user's role or position within the company.

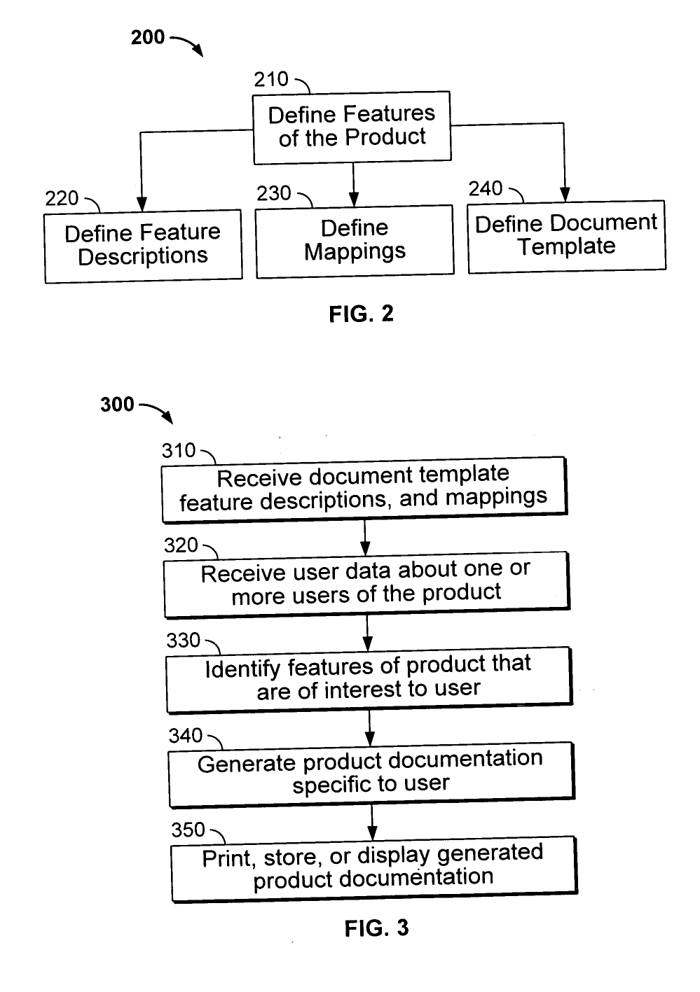

As shown in FIG. 2, in a method 200 in accordance with one implementation of the invention, the design module interacts with a user to define features of a product (step 210). Once the product features are defined, the feature descriptions are generated (step 220), the mapping information is generated (step 230) and the document template is generated (step 240). These actions (step 220, 230, and 240) can be performed in any order.

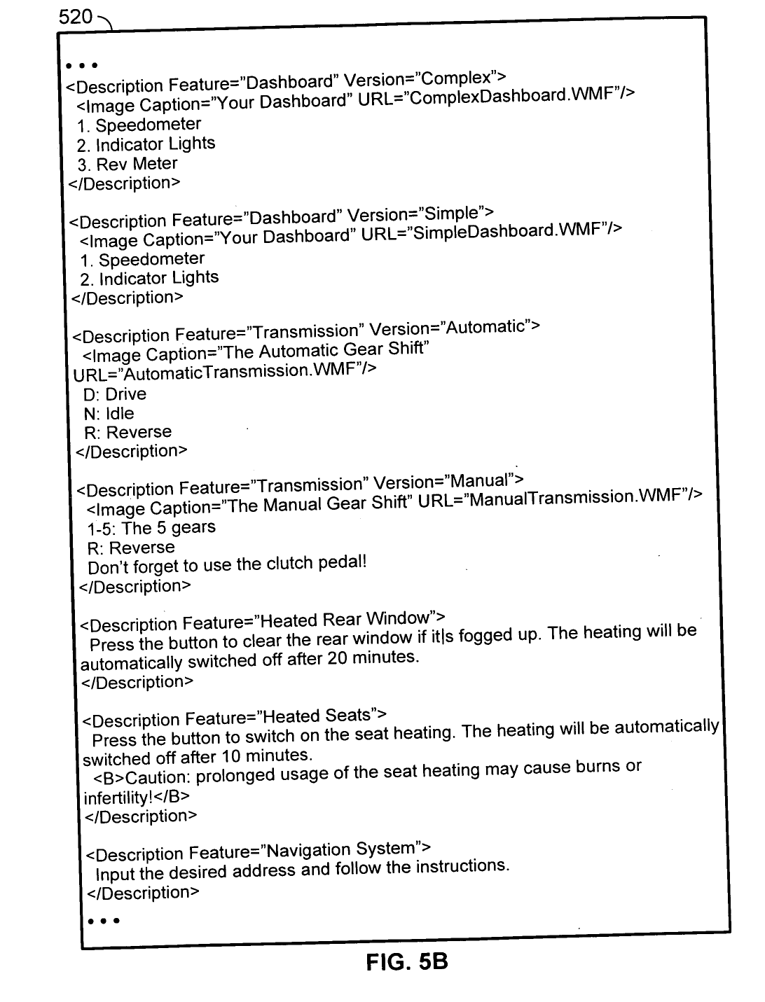

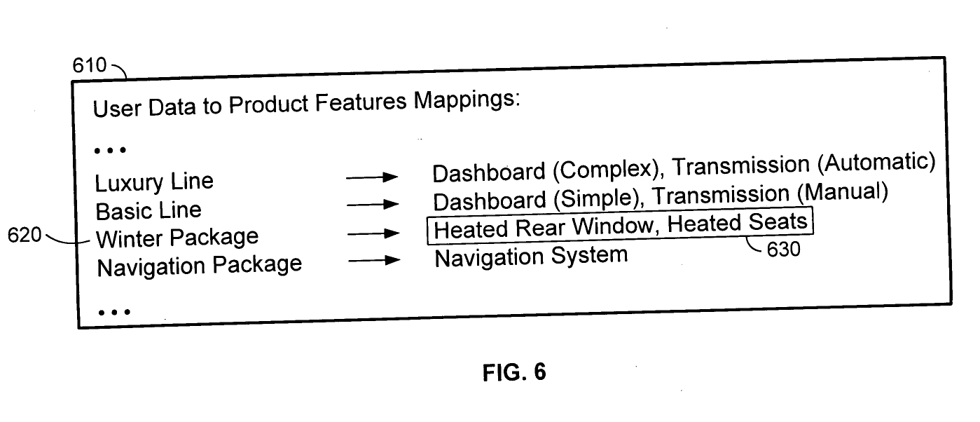

FIG. 5A illustrates a set of product features 510. FIG. 5B illustrates feature descriptions 520 defined for the set of product features shown in FIG. 5A. An example of mapping information 610 is shown in FIG. 6. In this example, the user data values in the mappings identify sales items that are purchasable by a user. Each sales item is mapped to one or more product features. For example, in the case of a car, one sales item 620 is a winter package. The winter package sales item is mapped to two product features 630, heated rear window and heated seats, meaning that when the winter package is purchased by a user, the user's car will come equipped with heated rear windows and heated seats.

As another example, in the case of an internal user within a company, the user data values can identify the user's roles within a company. Each user role can be mapped to the product features that are relevant to that role. The role of user interface developer, for example, could be mapped to the user interface features of the product.

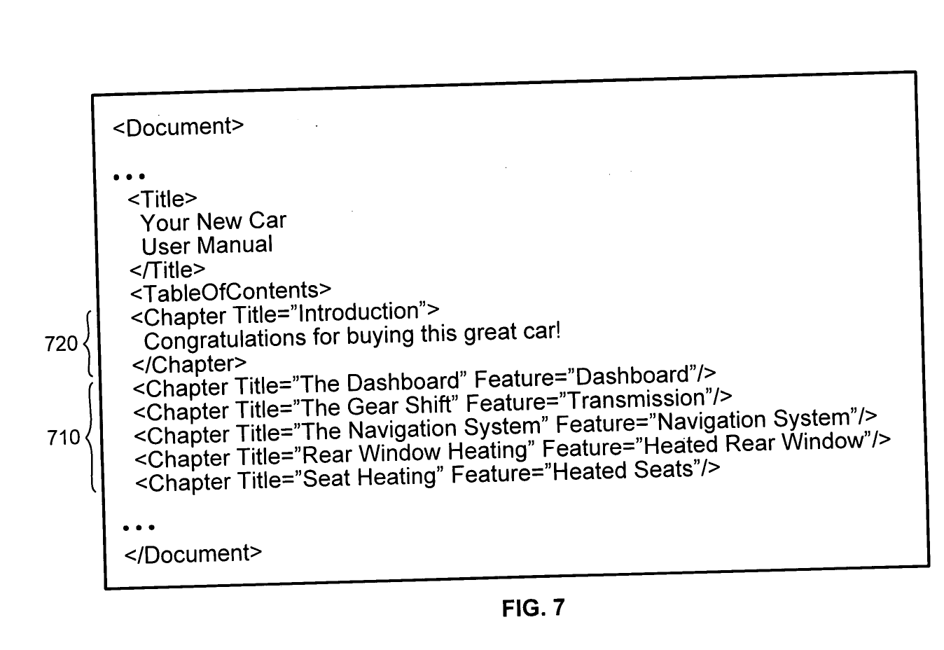

An example of a document template implemented as an XML (extensible markup language) document is shown in FIG. 7. As shown, the document template does not include the feature descriptions themselves, but only references 710 to the feature descriptions. In addition to the feature description references, the document template can also include references to general (non-feature-specific) content, for example, an introduction 720, and references to essential feature descriptions, that is, feature descriptions that are always included in the documentation.

The document template, feature descriptions, and mappings defined by the design module are used by the assembly module to generate an output document containing product documentation that is tailored to the interests of a particular user, as will be now be described.

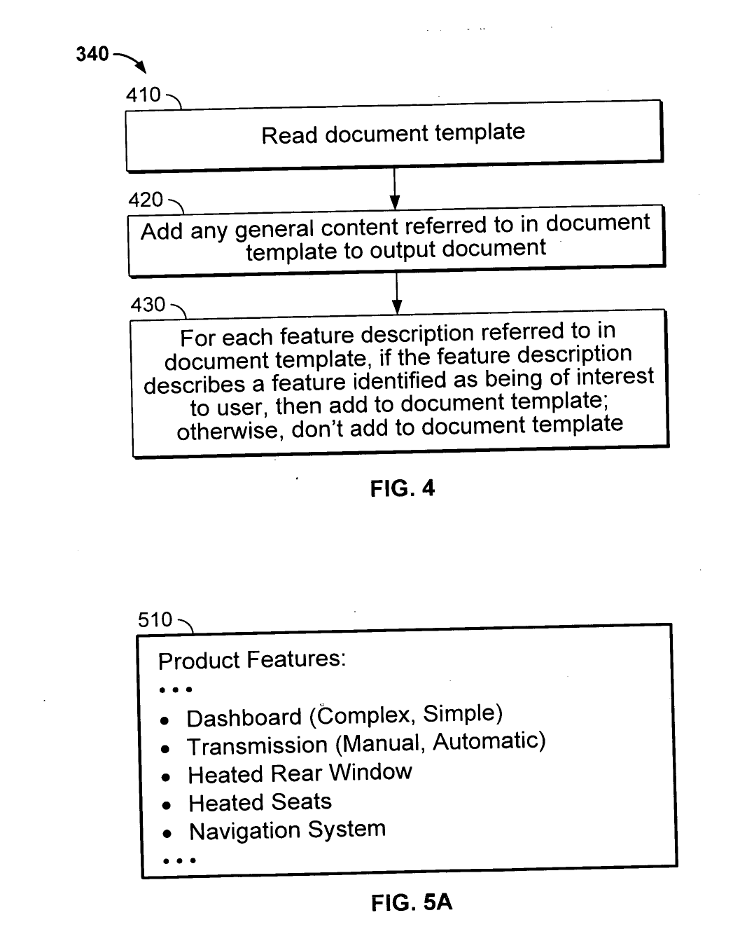

As shown in FIG. 3, in a method 300 in accordance with one implementation of the invention, the assembly module receives from the design module the document template, feature descriptions, and mappings (step 310). The assembly module also receives user data about one or more users of the product (step 320). The user data can be received from a user, for example, as part of a request to generate the documentation. Alternatively, the user data can be retrieved from stored location within the system, for example, from a database containing user profiles or sales and licensing records.

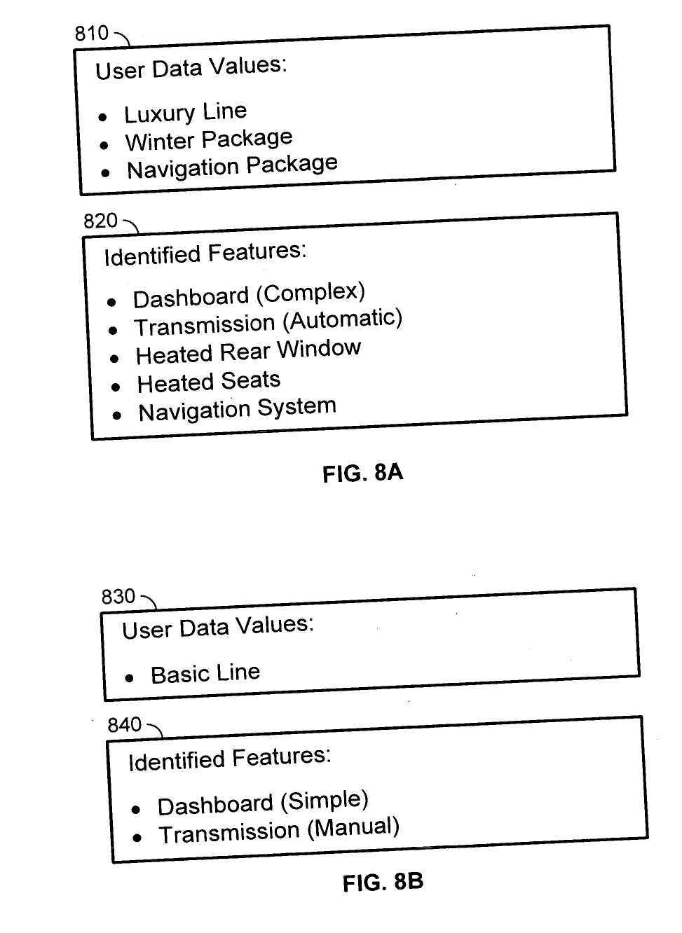

For each user, the assembly module identifies one or more features of the product that are of interest to the user (step 330). These features are identified by comparing the received user data to the mapping information that maps user data values to product features. FIG. 8A illustrates user data 810 about a first user and the features 820 identified as being of interest to the first user based on the mapping information shown in FIG. 6. FIG. 8B illustrates user data 830 about a second user and the features 840 identified as being of interest to the second user based on the mapping information shown in FIG. 6.

For each user, the assembly module generates product documentation specific to the user (step 340). As shown in FIG. 4, in one implementation, to generate the product documentation, the assembly module reads the document template (step 410). Any general content referred to in the document template is added to the output document containing the documentation (420). For each feature description referenced in the document template, if the feature description describes one of the features identified as being of interest to the user, then the feature description is added to the output document (step 430). Otherwise, the feature description is not added to the output document.

The output document containing the generated product documentation can then be printed, displayed, or stored (step 350). The output document can be stored in a single file, in a portion of a file that also contains other documents, or in multiple files.

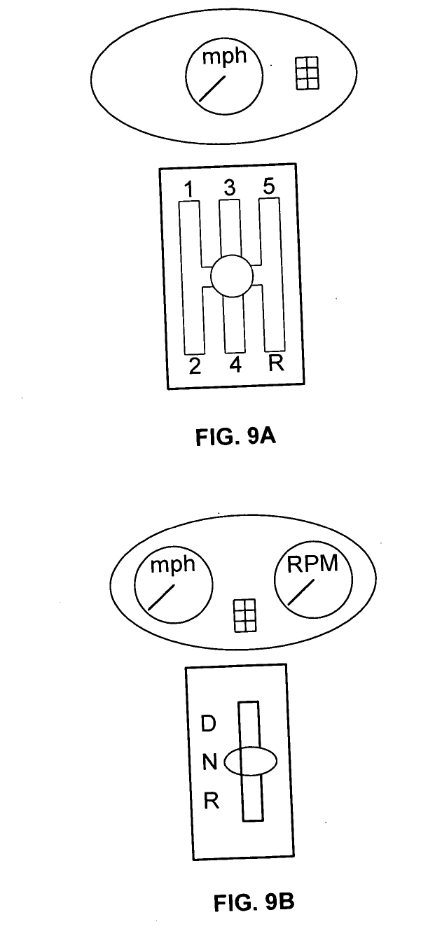

FIG. 9A illustrates product documentation generated for the first user based on the user data shown in FIG. 8A. FIG. 9B illustrates product documentation generated for the second user based on the user data shown in FIG. 8B.

The above-described system for generating documentation for a product can be implemented as part of a larger system. For example, the above-described system can be implemented as part of a system for developing products, or as part of a system for configuring or ordering products. The above-described system is generally applicable to generating documentation for any industrial or consumer product that comes in different configurations.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the operations of the invention can be performed in a different order and still achieve desirable results. In certain implementations, multitasking and parallel processing may be preferable. Other embodiments are within the scope of the following claims

What is claimed is:

1. A computer program product, tangibly embodied in an information carrier, the computer program product being operable to cause data processing apparatus to perform operations comprising:
receiving a set of feature descriptions for a product;
receiving a document template, the document template including references to feature descriptions in the set of feature descriptions;
receiving user data about a first user and different user data about a second user;
receiving mapping information that maps user data values to product features; and
for each user:
using the mapping information and the respective user data to identify product features that are of interest to the user; and
generating documentation for the product specific to the user, including reading the document template; and for each feature description referred to in the document template, adding the feature description to the documentation if the feature description describes one of the product features identified as being of interest to the user, otherwise, not adding the feature description to the documentation.

2. The computer program product of claim 1, wherein the respective user data identifies a user role performed by the respective user and the mapping information maps user roles to product features.

3. The computer program product of claim 1, wherein the respective user data identifies sales items in a purchase order placed by the respective user and the mapping information maps sales items to product features.

4. The computer program product of claim 1, wherein the documentation generated for the first user includes a different subset of the feature descriptions than the documentation generated for the second user.

5. The computer program product of claim 1, wherein:
the document template further includes references to general content; and
generating documentation for the product further includes adding the general content to the documentation.

6. The computer program product of claim 1, wherein the set of feature descriptions includes at least one feature description that includes graphics.

7. The computer program product of claim 1, wherein the product is an automobile.

8. The computer program product of claim 1, wherein the product is a software program.

9. A method comprising:
receiving a set of feature descriptions for a product;
receiving a document template, the document template including references to feature descriptions in the set of feature descriptions;
receiving user data about a first user and different user data about a second user;
receiving mapping information that maps user data values to product features; and
for each user:
using the mapping information and the respective user data to identify product features that are of interest to the user; and
generating documentation for the product specific to the user, including reading the document template; and for each feature description referred to in the document template, adding the feature description to the documentation if the feature description describes one of the product features identified as being of interest to the user, otherwise, not adding the feature description to the documentation.

10. The method of claim 9, wherein the respective user data identifies a user role performed by the respective user and the mapping information maps user roles to product features.

11. The method of claim 9, wherein the respective user data identifies sales items in a purchase order placed by the respective user and the mapping information maps sales items to product features.

12. The method of claim 9, wherein the documentation generated for the first user includes a different subset of the feature descriptions than the documentation generated for the second user.

13. The method of claim 9, wherein:
the document template further includes references to general content; and
generating documentation for the product further includes adding the general content to the documentation.

14. The method of claim 9, wherein the set of feature descriptions includes at least one feature description that includes graphics.

15. A system comprising:
means for receiving a set of feature descriptions for a product;
means for receiving a document template, the document template including references to feature descriptions in the set of feature descriptions;
means for receiving user data about a first user and different user data about a second user;
means for receiving mapping information that maps user data values to product features; and
means for, for each user:
using the mapping information and the respective user data to identify product features that are of interest to the user; and
generating documentation for the product specific to the user, including reading the document template; and for each feature description referred to in the document template, adding the feature description to the documentation if the feature description describes one of the product features identified as being of interest to the user, otherwise, not adding the feature description to the documentation.

16. The system of claim 14, wherein the respective user data identifies a user role performed by the respective user and the mapping information maps user roles to product features.

17. The system of claim 14, wherein the respective user data identifies sales items in a purchase order placed by the respective user and the mapping information maps sales items to product features.

18. The system of claim 14, wherein the documentation generated for the first user includes a different subset of the feature descriptions than the documentation generated for the second user.

19. The system of claim 14, wherein:
the document template further includes references to general content; and
means for generating documentation for the product further includes means for adding the general content to the documentation.

20. The system of claim 14, wherein the set of feature descriptions includes at least one feature description that includes graphics.
